(19) United States
(12) Patent Application Publication
(10) Pub. No.: US 2022/0043977 A1
(43) Pub. Date: Feb. 10, 2022

(54) DETERMINING USER COMPLAINTS FROM UNSTRUCTURED TEXT

(71) Applicant: INTERNATIONAL BUSINESS MACHINES CORPORATION, ARMONK, NY (US)

(72) Inventors: Mohan Nagraj Dani, Bangalore (IN); Samir Katti, Bangalore (IN); Ramesh G. Srinivasan, Bengaluru (IN); Harshavardhan Changappa, Bangalore (IN); Raviprasad Pentakota, Bangalore (IN)

(21) Appl. No.: 16/984,220

(22) Filed: Aug. 4, 2020

(51) Int. Cl. G06F 40/289; G06Q 30/00; G06F 40/284; G06F 40/253; G06F 40/30

(52) U.S. Cl. CPC G06F 40/289; G06Q 30/016; G06F 40/30; G06F 40/253; G06F 40/284

(57) ABSTRACT

A method, computer system, and a computer program product for complaint identification is provided. The present invention may include processing one or more sentences of a received communication. The present invention may include determining that at least one phrase of the processed sentence has a negative status. The present invention may include contextualizing the at least one phrase of the processed sentence. The present invention may include identifying a complaint within the at least one phrase of the processed sentence.

### BACKGROUND

The present invention relates generally to the field of computing, and more particularly to customer service systems.

Businesses, including commercial and/or retail institutions, among other things, with dedicated customer service personnel, may receive numerous email communications daily from a variety of sources. Filtering received email communications to identify written complaints may be essential in maintaining regulatory compliance. However, the filtering of a received email communication may be both labor intensive and time consuming and may delay a response time back to a sender of the email communication. Legal and financial implications of not addressing received email complaints may also follow.

### SUMMARY

Embodiments of the present invention disclose a method, computer system, and a computer program product for complaint identification. The present invention may include processing one or more sentences of a received communication. The present invention may include determining that at least one phrase of the processed sentence has a negative status. The present invention may include contextualizing the at least one phrase of the processed sentence. The present invention may include identifying a complaint within the at least one phrase of the processed sentence.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for complaint identification according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for complaint identification. As such, the present embodiment has the capacity to improve the technical field of customer service systems by discarding irrelevant words during a preprocessing phase, performing filtering tasks to reduce a number of irrelevant terms in a corpus dictionary, and contextualizing phrases as positive, negative or neutral. Such preprocessing of corpus dictionaries reduces the computational complexity of models derived from such corpus dictionaries, thereby improving the speed and accuracy of such models.

The present invention may contextualize phrases with identified nouns and verbs and may subsequently classify the contextualized phrases as positive, negative or neutral. Received emails may then be recognized as including complaints based on a negative classification. More specifically, the present invention may include processing one or more sentences of a received communication. The present invention may include determining that at least one phrase of the processed sentence has a negative status. The present invention may include contextualizing the at least one phrase of the processed sentence. The present invention may include identifying a complaint within the at least one phrase of the processed sentence.

As described previously, businesses, including commercial and/or retail institutions, among other things, with dedicated customer service personnel, may receive numerous email communications daily from a variety of sources. Filtering received email communications to identify written complaints may be essential in maintaining regulatory compliance. However, the filtering of a received email communication may be both labor intensive and time consuming and may delay a response time back to a sender of the email communication. Legal and financial implications of not addressing received email complaints may also follow.

Therefore, it may be advantageous to, among other things, enable a means by which businesses may automatically identify complaint-specific emails immediately upon receipt. This may improve the business' response time back to a sender of the email communication and may avoid any legal and financial implications.

The present invention may discard irrelevant words directly during a preprocessing phase. In order to reduce a number of irrelevant terms in a corpus dictionary, a number of term filtering tasks may be performed, including, but not limited to, parsing of large blocks of unstructured text into smaller blocks of unstructured text, tokenizing the blocks of text into sentences and words, and tagging the words with appropriate parts of speech.

The present invention may contextualize phrases with identified nouns and verbs and may subsequently classify the contextualized phrases as positive, negative or neutral. Received emails may then be recognized as including complaints based on a negative classification.

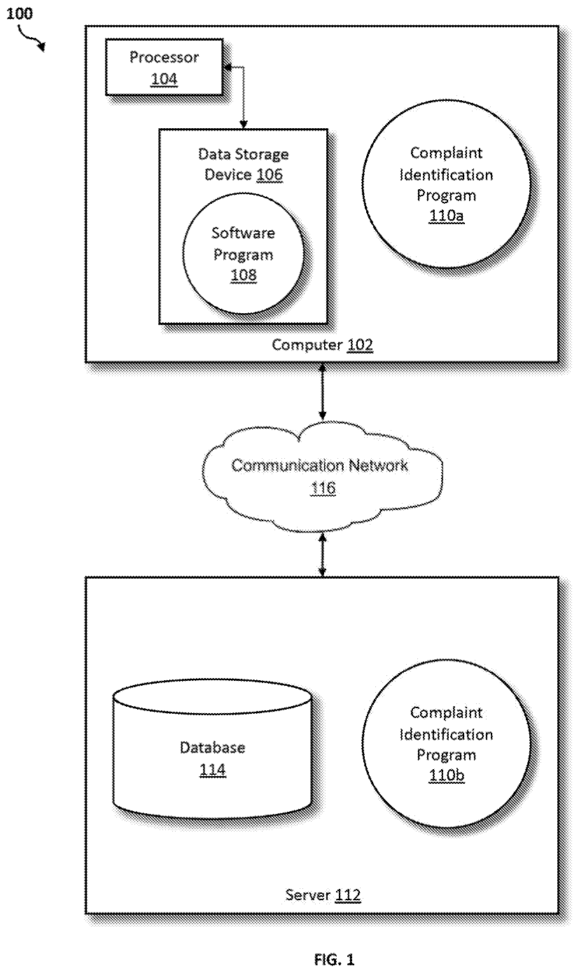

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a complaint identification program 110a. The networked computer environment 100 may also include a server 112 that is enabled to run a complaint identification program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

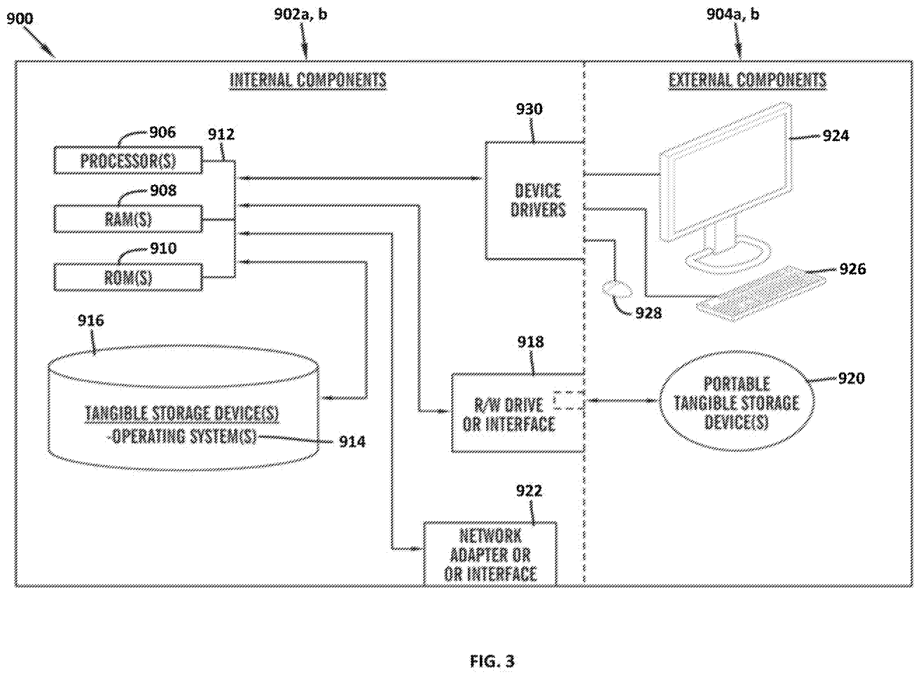

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the complaint identification program 110a, 110b may interact with a database 114 that may be embedded in various storage devices, such as, but not limited to a computer/mobile device 102, a networked server 112, or a cloud storage service.

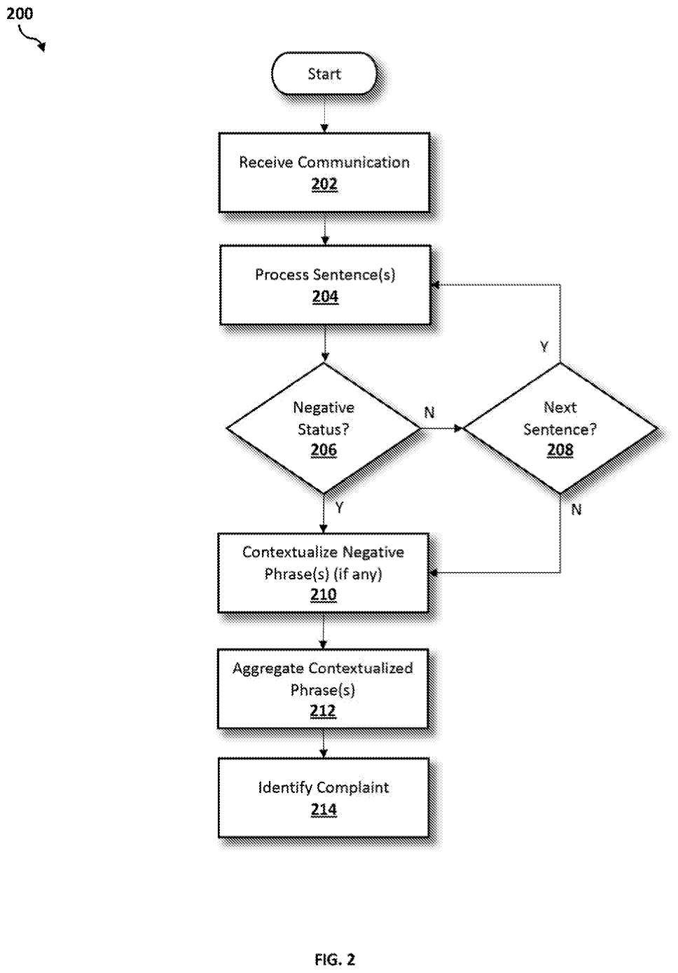

According to the present embodiment, a user using a client computer 102 or a server computer 112 may use the complaint identification program 110a, 110b (respectively) to discard irrelevant words during a preprocessing phase, perform filtering tasks to reduce a number of irrelevant terms in a corpus dictionary, and contextualize phrases as positive, negative or neutral. The complaint identification method is explained in more detail below with respect to FIG. 2.

Referring now to FIG. 2, an operational flowchart illustrating the exemplary complaint identification process 200 used by the complaint identification program 110a and 110b (i.e., the complaint identification program 110a, 110b) according to at least one embodiment is depicted.

At 202, a communication is received. A communication may be an email communication. The email communication may include unstructured text (e.g., data that does not follow a predefined format) which may be analyzed by the complaint identification program 110a, 110b.

For example, the complaint identification program 110a, 110b receives an email which states, “I am no longer playing games with ABC Bank. I have contacted the FTC. It has been 4 months and I do not have the copy of the document which indicates that I was fraudulently charged by Summers Restaurant.”

At 204, the received communication is processed. Processing of the received communication may include breaking down the received communication into paragraphs and further into sentences. Processing of the received communication may include sentence tokenization (e.g., where a received communication is segmented into single word and/or single phrase tokens). Sentence tokenization may be a technique used to split a string of text into a list of tokens. A token may be a smaller component of a larger framework (e.g., a word within a sentence and/or a sentence within a paragraph).

A rule-based parts of speech tagging method may then be used which utilizes dictionary and/or lexical tags to tag each word. Words may be tagged with the words' appropriate parts of speech after the received communication has been tokenized, with each word and/or word and punctuation (depending on the implementation of the tokenization and/or rule-based parts of speech tagging method) being treated as separate tokens with specific parts of speech tags. The rule-based parts of speech tagging method may be a trained model which applies a list of parts of speech tags to the tokenized words.

The complaint identification program 110a, 110b may process each paragraph of the received communication (e.g., the email) by performing the same analysis for each paragraph (e.g., extracting parts of speech, nouns, verbs, and/or phrases, among other things). A rule-based parts of speech tagging method may be used which utilizes dictionary and/or lexical tags to tag each word.

For example, a noun-verb phrase may be a unique combination of a noun occurring in the proximity of a verb. The verb may describe an action performed by the noun. Typically, a sentence may be comprised of multiple parts of speech including nouns, verbs, adverbs, and/or adjectives, among other things. Verbs located within close proximity to a related noun may provide a subjective context within a sentence. The proximity and relevance of a verb and a noun may form a unique combination within a given sentence. The noun-verb phrase identification may be further expanded to other combinations of parts of speech in the sentence in order to identify additional contexts and/or subjects. The identification of a noun-verb phrase may include identifying a noun and any words relevant to the noun, including verbs describing the noun's actions.

Continuing with the above example, which began at step 202 above, the complaint identification program 110a, 110b identifies the following nouns: games, ABC Bank, FTC, months, document, and Summers Restaurant; the following verbs: playing, contact, copy, and charged; and the following phrases: no longer, and do not have.

At 206, the complaint identification program 110a, 110b determines whether a phrase of the processed sentence has a negative status. The complaint identification program 110a, 110b may identify a phrase as positive, negative, or neutral. Sentiment analysis application programming interfaces (API) may be used to dynamically determine a sentiment of an analyzed phrase (e.g., of a sentence). Sentiment analysis may be the interpretation and classification of emotions (e.g., positive, negative, neutral) within text using text analysis techniques. A sentiment analysis application programming interface (API) may determine whether language in an analyzed phrase (e.g., a phrase of the processed sentence) is temperamental, angry, disappointed, sad, or happy, among other things.

For example, a sentiment analysis application programming interface (API) may use natural language processing (NLP) techniques and a machine learning model to train data with a set of emotions (e.g., positive, negative, neutral) and to thereafter classify additional data based on the trained data. A sentiment analysis API may be trained by loading a pretrained word embedding model and an opinion lexicon listing positive and negative words, and then training the sentiment analysis API using word vectors of the positive and negative words. A sentiment may be determined based on calculated scores of the words from a string of text. Using this method, for example, the sentiment analysis API may extract a sentiment from a string of text (e.g., from a phrase of the processed sentence taken from the received email communication).

Continuing with the above example, the complaint identification program 110a, 110b determines that the identified phrases (e.g., no longer and do not have) are negative phrases.

At 208, the complaint identification program 110a, 110b determines whether there is an additional sentence. If a phrase is identified as positive or neutral, then the complaint identification program 110a, 110b may proceed to a next sentence, if one exists, in the received communication (e.g., the email communication).

At 210, negative phrases of the processed sentence (if any) are contextualized. The negative phrases of the processed sentence may be contextualized with any identified nouns and verbs, as described previously with respect to step 204 above. Contextualization may be a representation for each word which depends on the context in which the word is used in a sentence. Identified negative phrases may be contextualized with various nouns and/or verbs, among other things, to confirm that the negative phrase is, in fact, negative.

Contextualization may be done to determine a subject and/or a domain within a given text (e.g., a processed sentence). Once a noun, verb, and/or phrase(s) are extracted from the processed sentence, combinations of one or more noun-phrases and/or one or more verb-phrases may be utilized to determine a subject of the processed sentence. For example, a noun and/or a noun-phrase and a verb and/or a verb-phrase may jointly describe a subject (e.g., an individual) and/or any related actions (e.g., an individual's actions) which may provide a distinct context of the processed sentence.

Here, during the contextualization process, an extracted phrase may be compared to an identified subject of the sentence and a relatedness may be determined (as described previously with respect to step 204 above). If it is determined that the phrase and the subject are not related, then the phrase may be deemed an unrelated outlier. If, however, it is determined that the phrase and the sentence are relating to the same context, then further processing may be performed. In this case, the noun-verb phrase along with a context of the sentence may be processed.

The method for extracting a subject from a sentence using a noun-verb phrase approach, as described here, may be unique in that the utilized method may handle any kinds of unstructured data without limitation and without need for a repository of any trained data set. The method may perform preprocessing, as described previously with respect to step 204 above, using a clustering methodology and/or other methodologies such as noun-verb phrases to extract a sentence subject. This technique may provide an accurate specific sentence context.

Continuing with the above example, the complaint identification program 110a, 110b contextualizes tokens obtained during the processing of the received sentence (as described previously with respect to step 204 above) and the following phrases are obtained: “no longer playing games,” “no longer playing ABC Bank,” “no longer playing FTC,” “no longer playing months,” and “no longer playing document.”

At 212, contextualized phrases are aggregated. All phrases obtained from the received communication may be aggregated and analyzed using sentiment analysis to determine which, if any, construes a negative sentiment and may be identified as a complaint. The contextualized negative noun-verb phrases may be aggregated in an in-memory list which may be neither stored nor persisted in a database. The aggregated list of contextualized phrases may be used as input for further processing by the complaint identification program 110a, 110b to determine if a processed sentence includes a complaint.

Using a clustering method, the complaint identification program 110a, 110b may determine whether a context of the negative contextualized sentences, which have added to the in-memory list, is within close proximity to a subject of the sentence. Only those phrases and sentences which are related may be analyzed using sentiment analysis to determine which, if any, construes a negative sentiment and may be identified as a complaint.

Sentiment analysis application programming interfaces (API) may also be used here to dynamically determine a sentiment of an analyzed phrase. A sentiment analysis application programming interface (API) may evaluate text and return a sentiment score and/or label for each analyzed sentence. For example, a sentiment analysis application programming interface (API) may determine whether language in an analyzed phrase is temperamental, angry, disappointed, sad, or happy, among other things.

A sentiment analysis application programming interface (API) may be used to resolve whether negative sentences are complaints or just negative statements, as all negative sentences need not be associated with a subject and need not be a complaint (e.g., “I am not happy”).

At 214, a complaint is identified. As described previously with respect to step 212 above, a complaint may be identified based on analysis of one or more connected APIs. Once the contextualization process is complete, as described previously with respect to step 210 above, and a list of noun-verb phrases is obtained, the list of noun-verb phrases may be processed by an aggregation component, as described previously with respect to step 212 above, to determine whether a complaint exists.

A complaint identified within a received communication may be flagged as same by the complaint identification program 110a, 110b. Complaints flagged by the complaint identification program 110a, 110b may relate to business and/or another endeavor pursued by the receiver of the received communication, and may be used to improve a response time in instances of the received identified complaint. Notice of a flagged complaint may be sent (e.g., via email communication) to a pre-configured system administrator (e.g., as configured within the complaint identification program 110a, 110b), among other things.

It may be appreciated that FIG. 2 provides only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the complaint identification program 110a in client computer 102, and the complaint identification program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the complaint identification program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the complaint identification program 110a in client computer 102 and the complaint identification program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the complaint identification program 110a in client computer 102 and the complaint identification program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

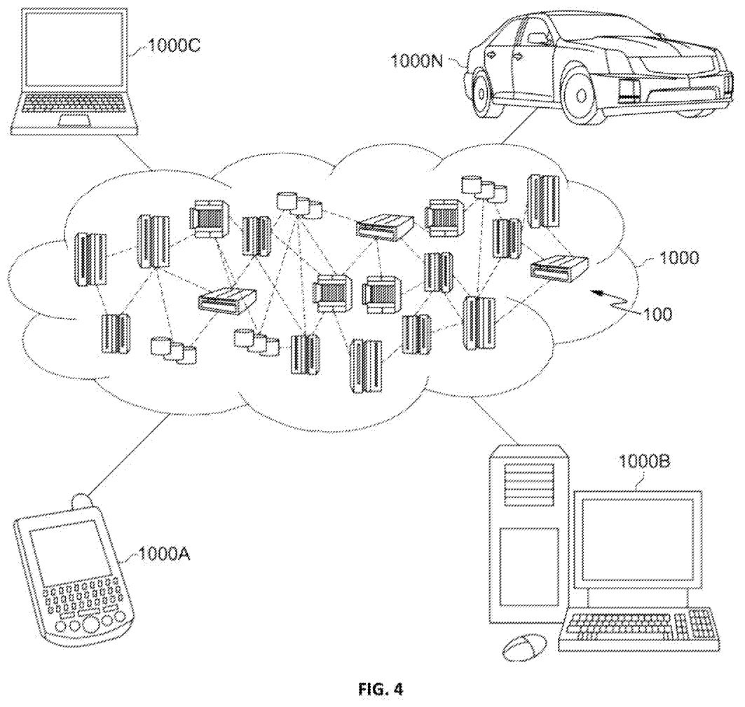

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

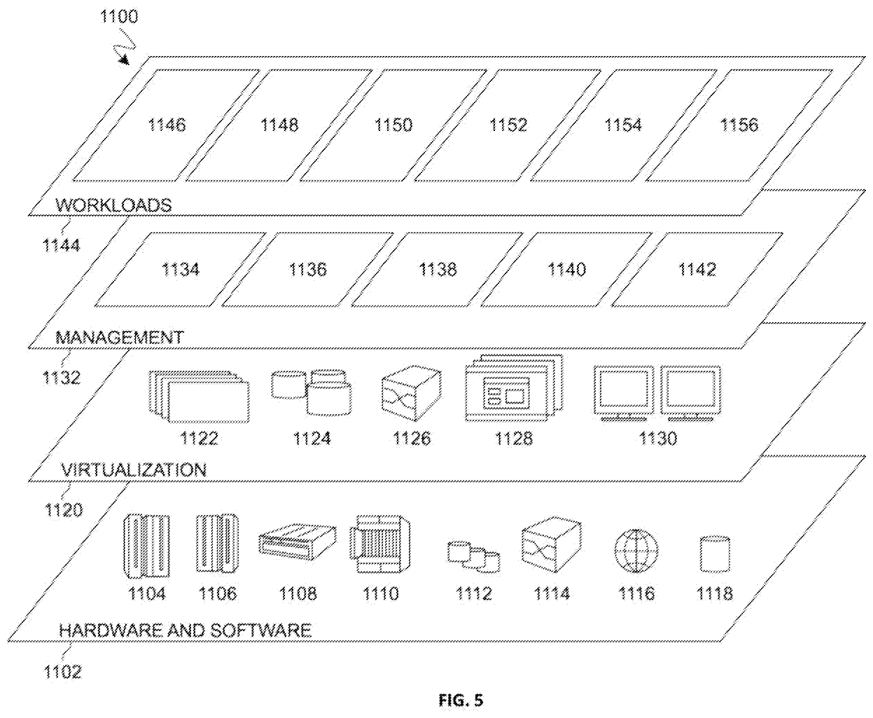

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and complaint identification 1156. A complaint identification program 110a, 110b provides a way to discard irrelevant words during a preprocessing phase, perform filtering tasks to reduce a number of irrelevant terms in a corpus dictionary, and contextualize phrases as positive, negative or neutral.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for complaint identification, the method comprising:
processing one or more sentences of a received communication;
determining that at least one phrase of the processed sentence has a negative status;
contextualizing the at least one phrase of the processed sentence; and
identifying a complaint within the at least one phrase of the processed sentence.

2. The method of claim 1, further comprising:
aggregating the at least one contextualized phrase of the processed sentence.

3. The method of claim 1, wherein the received communication is an email communication containing unstructured text.

4. The method of claim 1, wherein processing the one or more sentences of the received communication further comprises:
tokenizing the received communication to generate a list of tokens; and
using a rule-based parts of speech (POS) tagging method to tag each token in the generated list of tokens with a part of speech.

5. The method of claim 1, wherein determining that at least one phrase of the processed sentence has the negative status further comprises:
using a sentiment analysis application programming interface (API) to analyze the at least one processed phrase.

6. The method of claim 4, wherein contextualizing the at least one phrase of the processed sentence further comprises:
determining a subject of the at least one processed phrase by using the generated list of tokens with the tagged part of speech.

7. The method of claim 1, wherein identifying the complaint within the at least one phrase of the processed sentence further comprises:
obtaining an aggregated list of noun-verb phrases of the received communication.

8. A computer system for complaint identification, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
processing one or more sentences of a received communication;
determining that at least one phrase of the processed sentence has a negative status;
contextualizing the at least one phrase of the processed sentence; and
identifying a complaint within the at least one phrase of the processed sentence.

9. The computer system of claim 8, further comprising:
aggregating the at least one contextualized phrase of the processed sentence.

10. The computer system of claim 8, wherein the received communication is an email communication containing unstructured text.

11. The computer system of claim 8, wherein processing the one or more sentences of the received communication further comprises:
tokenizing the received communication to generate a list of tokens; and
using a rule-based parts of speech (POS) tagging method to tag each token in the generated list of tokens with a part of speech.

12. The computer system of claim 8, wherein determining that at least one phrase of the processed sentence has the negative status further comprises:
using a sentiment analysis application programming interface (API) to analyze the at least one processed phrase.

13. The computer system of claim 11, wherein contextualizing the at least one phrase of the processed sentence further comprises:
determining a subject of the at least one processed phrase by using the generated list of tokens with the tagged part of speech.

14. The computer system of claim 8, wherein identifying the complaint within the at least one phrase of the processed sentence further comprises:
obtaining an aggregated list of noun-verb phrases of the received communication.

15. A computer program product for complaint identification, comprising:
one or more non-transitory computer-readable storage media and program instructions stored on at least one of the one or more tangible storage media, the program instructions executable by a processor to cause the processor to perform a method comprising:
processing one or more sentences of a received communication;
determining that at least one phrase of the processed sentence has a negative status;
contextualizing the at least one phrase of the processed sentence; and
identifying a complaint within the at least one phrase of the processed sentence.

16. The computer program product of claim 15, further comprising:
aggregating the at least one contextualized phrase of the processed sentence.

17. The computer program product of claim 15, wherein the received communication is an email communication containing unstructured text.

18. The computer program product of claim 15, wherein processing the one or more sentences of the received communication further comprises:
tokenizing the received communication to generate a list of tokens; and
using a rule-based parts of speech (POS) tagging method to tag each token in the generated list of tokens with a part of speech.

19. The computer program product of claim 15, wherein determining that at least one phrase of the processed sentence has the negative status further comprises:
using a sentiment analysis application programming interface (API) to analyze the at least one processed phrase.

20. The computer program product of claim 18, wherein contextualizing the at least one phrase of the processed sentence further comprises:
determining a subject of the at least one processed phrase by using the generated list of tokens with the tagged part of speech.
